(19) United States
(12) Patent Application Publication
(10) Pub. No.: US 2025/0166442 A1
(43) Pub. Date: May 22, 2025

(54) MEDIA PROCESSING DEVICE

(71) Applicant: Glory Ltd., Himeji-shi (JP)

(72) Inventor: Yusuke YOSHIDA, Himeji-shi (JP)

(73) Assignee: Glory Ltd., Himeji-shi (JP)

(21) Appl. No.: 18/949,223

(22) Filed: Nov. 15, 2024

(30) Foreign Application Priority Data
Nov. 16, 2023 (JP) 2023-194868

(51) Int. Cl. G07D 3/14; G07D 1/06

(52) U.S. Cl. CPC G07D 3/14; G07D 1/06; G07D 2201/00

(57) ABSTRACT

A media processing device comprises a transport surface along which a medium is transported, and a transporter having a contact portion with which the medium comes into contact, the contact portion pushing and transporting the medium. The transport surface includes a first transport surface along which the medium is transported by the transporter, and a second transport surface that is located downstream of the first transport surface in a transport direction of the transporter, the second transport surface along which the medium separated from the contact portion is transported. The contact portion moves in a different direction which is different from the transport direction relative to the first transport surface on a downstream side of the first transport surface. A step is between the first transport surface and the second transport surface such that the second transport surface is recessed with respect to the first transport surface.

### CROSS-REFERENCE TO RELATED APPLICATION

The present application claims priority to Japanese patent application JP 2023-194868, filed Nov. 16, 2023, the entire contents of which are incorporated herein by reference.

### TECHNICAL FIELD

The present disclosure relates to a media processing device that performs predetermined processing on media such as coins.

### BACKGROUND

Conventionally, a medium processing device such as a coin processing device performs processes such as depositing and dispensing coins. Inside the coin processing device, a transport unit transports coins to storage units and the like. The conveying unit may include a transport member having a contact unit that comes into contact with the coin and that pushes and transports the coin with the contact section.

The conveying unit may include a first conveying path, a second conveying path provided above the first conveying path, a turning portion that changes the conveying direction of coins conveyed by the first conveying path by 180° and sends them to the second conveying path, and an endless belt with multiple protrusions provided at equal intervals. Coins paid out from a feeding part to the conveying unit are transported by being hooked onto the protrusions. The protrusions are contact parts that come into contact with coins, and the belts are conveying members that push and convey the coins by means of the contact parts.

In this coin processing device, a guide unit for guiding coins from the second transport path to the feeding part is provided at a downstream end of the second transport path, below the pulley around which the belt is stretched. The downstream end of the second conveying path is bent in an arc shape of approximately 90 degrees along the outer periphery of the pulley and is connected to the guide portion. The coins transported by the transport unit are sorted into one of the sorting areas such as the coin storage unit, and coins that are not sorted into any of the sorting areas are sent from the second transport path to the guide unit and returned to the feeding part.

### SUMMARY

A coin processing device according to the present disclosure comprises a transport surface along which a medium is transported; and a transporter having a contact portion with which the medium comes into contact, the contact portion pushing and transporting the medium. The transport surface includes a first transport surface along which the medium is transported by the transporter, and a second transport surface that is located downstream of the first transport surface in a transport direction of the transporter, the second transport surface along which the medium separated from the contact portion is transported. The contact portion moves in a different direction which is different from the transport direction relative to the first transport surface on a downstream side of the first transport surface. A step is between the first transport surface and the second transport surface such that the second transport surface is recessed with respect to the first transport surface.

### BRIEF DESCRIPTION OF THE DRAWINGS

FIG. 1 illustrates a schematic configuration of a media processing device.

FIG. 2 illustrates a perspective view of a feeder, a storage, and a transporter of the media processing device.

FIG. 3 illustrates a perspective view of a part of the feeder and the transporter.

FIG. 4 illustrates a cross-sectional view of the feeder, the storage, and a return chute of the media processing device.

FIG. 5 illustrates a perspective view of a transport belt.

FIG. 6 illustrates a periphery of a second transport surface of a transport path member of the media processing device.

FIGS. 7A and 7B illustrate cross-sectional views of a main part of the transport path member taken along lines AA′ and BB′ in FIG. 6, respectively.

FIGS. 8A-8D illustrate movement of a coin transported on a transport surface from a terminal end of a first transport surface to the second transport surface.

FIGS. 9A-9C illustrate movement of coins transported on the transport surface from the terminal end of the first transport surface to the second transport surface.

FIGS. 10A and 10B illustrate a configuration of a position detection mechanism.

FIG. 11 illustrates a block diagram showing the main configuration of the media processing device.

FIGS. 12A and 12B illustrate a deposit process and a withdrawal process, respectively, of the media processing device.

FIG. 13 illustrates a withdrawal preparation process of the media processing device.

FIG. 14 illustrates a flowchart of a jam handling process of the media processing device.

FIG. 15 illustrates a flowchart of a special jam release process included in the jam response process.

FIGS. 16A-16D illustrate a jam handling process of the media processing device.

### DETAILED DESCRIPTION

In the conventional coin processing device, a coin (or other item) is pushed by a protrusion and transported, bends along a pulley at the downstream end of the second transport path, and then moves away from the protrusion due to gravity acting on the coin and toward the guide section. The projection from which the coin has been released travels along the outer periphery of the pulley in a direction different from the direction from the second transport path toward the guide section, and passes through the gap between the pulley and the guide section to leave the second transport path.

However, in the conventional coin processing device, if a coin does not smoothly separate from the protrusion at the downstream end of the second transport path, the coin may be carried in a direction a direction away from where it should travel, i.e., toward the guide part. Such problems may occur in media processing devices other than coin processing devices that transport the coin or other item similarly to the transporter of the coin processing device discussed above.

The inventor of the present disclosure developed technology as outlined in this disclosure to address the above-discussed problems with conventional technology. In particular, the inventor has developed technology in which a transported medium may smoothly leave a contact portion of a transport member and easily move in an intended direction.

A media processing device according to the present disclosure may include a transport surface along which the medium is transported, and a transport member that has a contact portion with which the medium comes into contact and that pushes and transports the medium by means of the contact portion. Here, the transport surface includes a first transport surface along which the medium is transported by the transport member, and a second transport surface which is downstream of the first transport surface in the transport direction by the transport member and along which the medium away from the contact portion is transported. The contact portion moves, on the downstream side of the first transport surface, in a direction different from a direction in which the second transport surface exists relative to the first transport surface, and leaves the transport surface. The transport surface is provided with a step between the first transport surface and the second transport surface, the step causing the second transport surface to be recessed with respect to the first transport surface.

For example, the second transport surface may be provided extending from the first transport surface in a direction in which the medium travels at an end of the first transport surface.

With an exemplary media processing device, the medium moves from the first transport surface toward the recessed second transport surface, making it easier for the medium to smoothly separate from the contact portion on the way to the second transport surface. This makes it difficult for the medium to be dragged along by the contact portion that moves in a direction different from the direction toward the second transport surface. Therefore, the medium can be moved smoothly from the first transport surface to the second transport surface.

Additionally, the transport surfaces may be configured such that, for example, at an end of the first transport surface, the medium advances in a generally horizontal direction towards the second transport surface. In this case, gravity hardly acts on the medium at the end of the first transport surface in the direction in which the medium is transported, so it is difficult to expect the medium to separate from the contact portion due to the action of gravity. However, with the above-described configuration, even if the effect of gravity cannot be expected, the medium can be easily separated from the contact portion.

In an exemplary media processing device, the transport member may include an endless transport belt, and the contact portion may include a protrusion that protrudes from the transport belt towards the transport surface. In this case, the protrusion can move in the different directions downstream of the first transport surface so as to follow an outer periphery of a pulley around which the transport belt is wound.

According to the above configuration, the medium is less likely to be dragged along by the protrusion that moves in a direction different from the direction toward the second transport surface along the outer periphery of the pulley. This makes it possible to smoothly move the medium transported on the first transport surface by the transport belt to the second transport surface.

An exemplary media processing device may be configured to further include a feeding section that feeds the medium onto the first transport surface. In this case, the second transport surface is disposed above the feeding section and can guide the medium being returned to the feeding section. Furthermore, the contact portion can move in the different direction above the payout portion and separate from the transport surface.

According to the above configuration, the medium can be efficiently fed to the feeding section via the second transport surface.

In the case of the above configuration, a configuration may be adopted in which the printer further includes a storage section that is disposed above the payout section and in which the medium is stored. The medium processing device may further include a sorting mechanism for sorting the medium guided by the second transport surface to the feed section or the storage section.

In this configuration, the medium can be efficiently transported to the feed section and the storage section via the second transport surface. In addition, since the transport member is unlikely to protrude toward the second transport surface side, it does not interfere with the storage section that is overlapped above the payout section.

An exemplary media processing device may be configured so that the contact portion moves in the different direction and leaves the transport surface from one side edge of the transport surface. In this case, the step may be provided obliquely with respect to the width direction of the transport surface so that the closer the medium is to one side edge of the transport surface, the faster it approaches the step.

According to the above configuration, when a coin reaches the step, the portion closer to one side edge of the transport surface, i.e., the portion on the side where the contact portion is separated from the transport surface, drops down first and assumes a lower position relative to the contact portion. Therefore, when the contact portion leaves the transport surface, it is more likely to separate from the medium, and the medium is more likely to move smoothly to the second transport surface. The media processing device may be configured so that the step is an inclined surface.

According to the above configuration, the medium that reaches the step goes down the slope, so unlike when the step is perpendicular to the first transport surface, the medium is less likely to float as it passes over the step, fall onto the second transport surface, and become unruly. This allows the medium to move more smoothly to the second transport surface.

In an exemplary media processing device, a configuration may be adopted that further includes a gate adjacent to the transport surface through which the contact portion moves in the different direction passes, and a guide portion that guides the medium transported on the first transport surface away from the gate in the width direction of the first transport surface as the medium approaches the second transport surface.

According to the above configuration, on the first transport surface, the medium heading toward the second transport surface is guided by the guide portion away from the gate, so that the medium is less likely to approach the gate when it leaves the first transport surface. Therefore, the medium is less likely to get caught in the gate, and jams are less likely to occur.

In the above-described configuration, a configuration may be adopted in which the gate is farther from the first transport surface than the guide portion is from the first transport surface in the width direction of the first transport surface.

With this configuration, it is even less likely that the medium that has left the first transport surface will come close to the gate.

An exemplary media processing device may be configured to further include a gate adjacent to the transport surface through which the contact portion moves in the different direction. In this case, the second transport surface may be configured to be recessed with respect to the first transport surface beyond a surface on which the gate is provided.

According to the above configuration, the medium reaching the second transport surface is lower than the gate, so the medium is less likely to get caught in the gate and jams are less likely to occur.

In the exemplary media processing device, the second transport surface may be configured to have a non-flat area that is not a flat surface.

According to the above configuration, the medium moving on the second transport surface passes through the non-flat region, so that the contact area between the surface of the medium and the second transport surface can be reduced. Therefore, even if the medium is wet or in a state in which the coefficient of friction is large, the frictional resistance generated between the surface of the medium and the second transport surface is small, so that it is possible to prevent the medium from becoming difficult to move on the second transport surface.

An exemplary media processing device may further include a drive source for driving the transport member, and a control unit for controlling the drive source. In this case, when the control unit determines that a media jam has occurred within a specified range around the step, it executes a jam clearance process that operates the drive source so that the contact portion moves to clear the jam.

According to the above configuration, even if a jam of the medium occurs around the step, it is possible to clear the jam because the contact portion does not smoothly separate from the medium.

When the jam release process is performed as described above, a configuration may be adopted in which a gate is further provided adjacent to the transport surface through which the contact portion that has moved in the different direction passes. In this case, the transport member may be provided with a plurality of the contact portions. The control unit may be configured to operate the drive source so that, as the jam removal process, the contact portion, which is located in a direction away from the transport surface than the gate, moves toward the gate and passes the position of the gate. The control unit may operate the drive source to reverse the transport member after the contact portion passes the position of the gate, so that the contact portion passes the position of the gate in the reverse direction. The control unit may operate the drive unit to reciprocate the contact portion within a predetermined range including a position of the gate. The control unit may operate the drive source to reciprocate the contact portion a plurality of times within the predetermined range.

With this configuration, when a medium gets caught in the gate and jams, it is possible to remove the jam by pushing the medium with the contact portion and removing it from the gate.

When the jam removal process is configured as described above, the control unit can be configured to detect the position of the contact part and determine whether or not a jam has occurred within the specified range based on the position of the contact part when a media jam occurs.

When a jam occurs in a predetermined range around the step, the protrusion may be located in a range corresponding to the predetermined range. Therefore, with the above-mentioned configuration, when the protrusion is located in the corresponding range, it can be determined that a jam has occurred in a predetermined range around the step.

In addition, the control unit may be configured to operate the drive source to retract and then advance the contact portion when a media jam is detected, and if the jam is not cleared by this operation, perform the jam removal process based on a determination that a media jam has occurred within the specified range. With this configuration, when a jam occurs on the first transport surface, it is possible to clear the jam without performing the jam clearance process.

Hereinafter, embodiments of the present disclosure will be described with reference to the drawings.

The media processing device 1 performs processes such as depositing and withdrawing media such as coins. Hereinafter, media processing device 1 may be referred to as a coin processing device. In media processing device 1, deposit port 100 and withdrawal port 200 are arranged on a front surface of the media processing device 1.

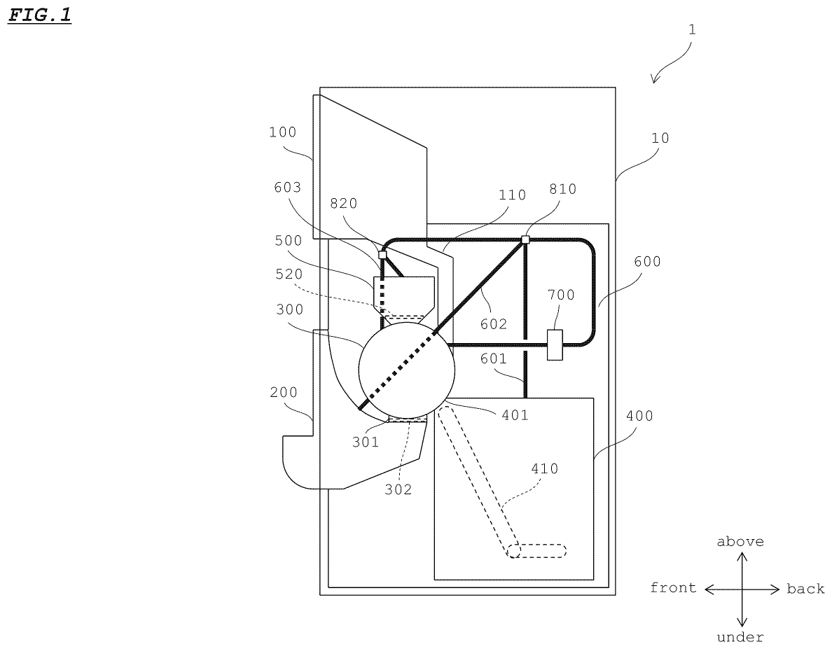

FIG. 1 illustrates a configuration of a media processing device 1. FIG. 1 shows the media processing device 1 as seen from the right side.

The media processing device 1 includes, within a housing 10, a deposit port 100, a withdrawal port 200, a feeder 300, a first storage 400, a second storage 500, a transporter 600, and a recognition device 700.

The deposit port 100 and the withdrawal port 200 are provided on the housing 10, i.e., on the front surface of the media processing device 1. The deposit port 100 is located above the withdrawal port 200. Coins to be deposited into the media processing device 1 are inserted into the deposit port 100. Coins dispensed from the media processing device 1 are discharged through the withdrawal port 200.

The feeder 300 is disposed below the deposit port 100. Coins inserted into the deposit port 100 are introduced into the feeder 300 via a deposit chute 110. The feeder 300 dispenses coins one by one to the transporter 600. Furthermore, a discharge port 301 connected to the withdrawal port 200 is provided at the bottom of the feeder 300. The discharge port 301 is closed by a shutter 302. If any deformed coins or foreign objects remain in the feeder 300, the shutter 302 is opened and these are discharged to the withdrawal port 200.

The first storage 400 is disposed below the feeder 300 and the transporter 600. The first storage 400 stores a mixture of coins of various denominations. The first storage 400 has a discharge port 401 provided at the upper end thereof connected to the feeder 300, and also has a transport mechanism 410 constituted by a conveyor or the like. The coins stored in the first storage 400 are transported by the transport mechanism 410 and discharged into the feeder 300 through the discharge port 401.

The second storage 500 is disposed above the feeder 300. The second storage 500 stores the coins transported by the transporter 600. A shutter 520 is provided at the bottom of the second storage 500, and when the shutter 520 opens, the coins in the second storage 500 fall into the feeder 300.

The transporter 600 is arranged between the feeder 300, the first storage 400, the second storage 500, and the withdrawal port 200, and transports coins among them. The transporter 600 is provided with a first sorting mechanism 810 and a second sorting mechanism 820. The first sorting mechanism 810 sorts the coins flowing through the transporter 600 to the first storage 400 side or the withdrawal port 200 side. The second sorting mechanism 820 sorts the coins flowing through the transporter 600 toward the second storage 500. Coins that are not distributed to any of the first storage 400, the withdrawal port 200, and the second storage 500 are returned to the feeder 300.

In the transporter 600, a storage chute 601 is provided between the first sorting mechanism 810 and the first storage 400, and a dispensing chute 602 is provided between the first sorting mechanism 810 and the withdrawal port 200. The coins slide down the storage chute 601 towards the first storage 400, and slide down the dispensing chute 602 towards the withdrawal port 200. Furthermore, the transporter 600 includes a return chute 603 between the second sorting mechanism 820 and the feeder 300. The coins slide down the return chute 603 towards the feeder 300.

The recognition device 700 is provided on the transporter 600 closer to the feeder 300 than the first sorting mechanism 810. The recognition device 700 recognizes the attributes of the coin flowing through the transporter 600 and outputs the recognition results. Attributes that can be identified include the coin's authenticity, denomination, and fitness. According to the identification result of the recognition device 700, the first sorting mechanism 810 and the second sorting mechanism 820 perform operations. Furthermore, the recognition device 700 also counts the coins. The recognition device 700 is configured by a sensor such as an optical sensor or a magnetic sensor, for example.

Next, the configurations of the feeder 300, the second storage 500 and the transporter 600 will be described in detail.

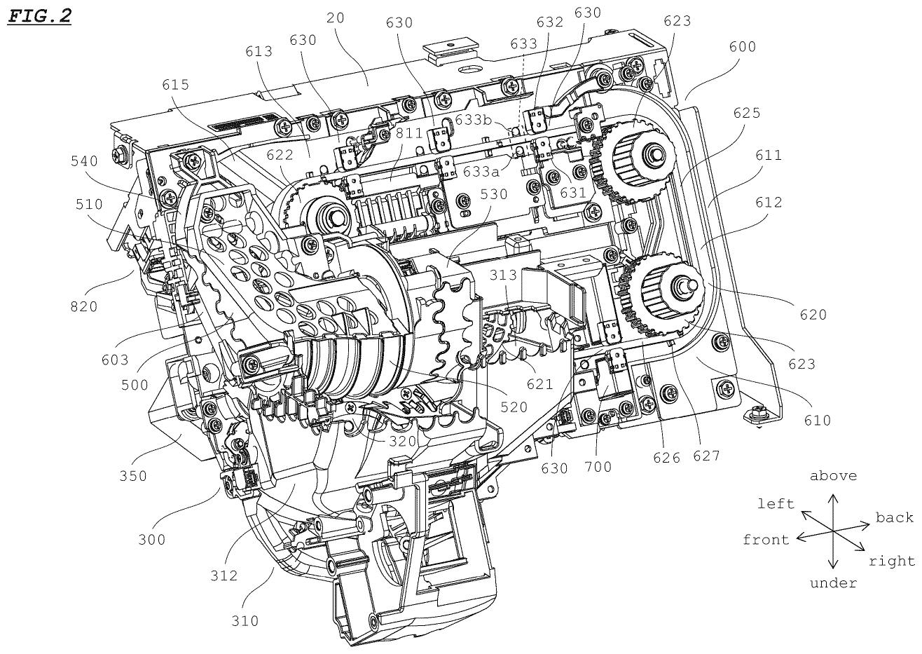

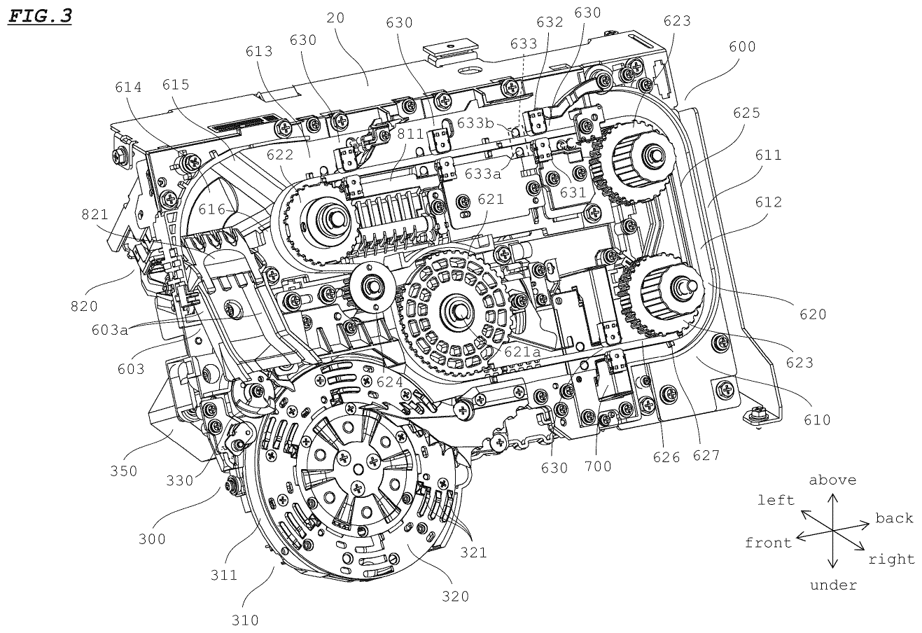

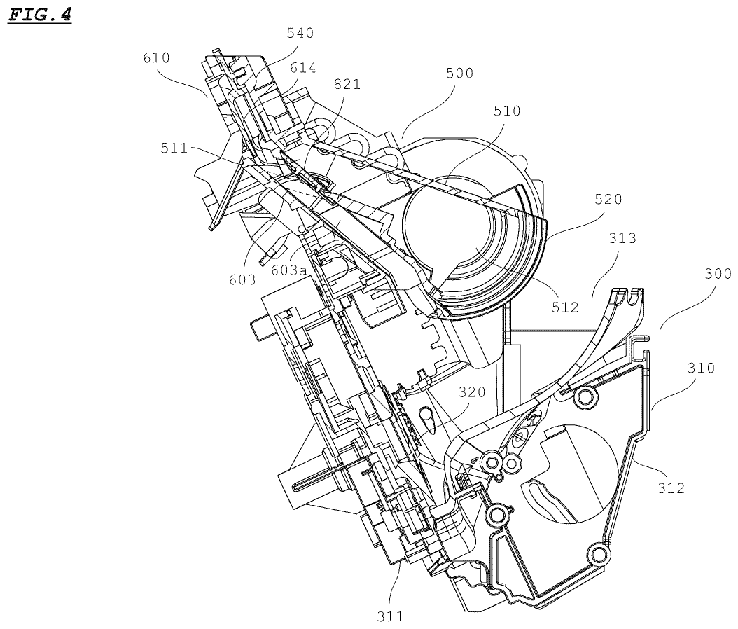

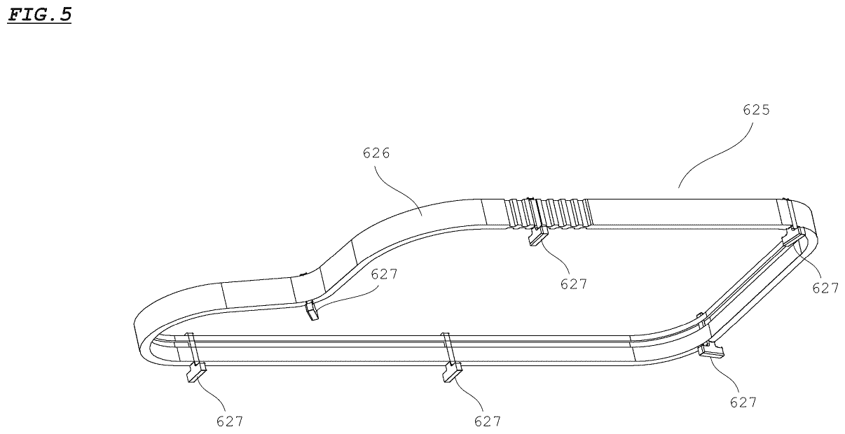

FIG. 2 is a perspective view showing the configurations of the feeder 300, the second storage 500, and the transporter 600. FIG. 3 is a perspective view showing a part of the feeder 300 and the configuration of the transporter 600. FIG. 3 shows the feeder 300 with the second member 312 of the housing 310 removed. FIG. 4 is a cross-sectional view showing the configuration of the feeder 300, the second storage 500 and the return chute 603. FIG. 5 is a perspective view of the transport belt 625.

Within the housing 10, the feeder 300, the second storage 500 and the transporter 600 are assembled to an installation plate 20.

The feeder 300 includes a housing 310, a rotating disk 320, and a delivery disk 330. The housing 310 is composed of a first member 311 in which a rotating disk 320 and a delivery disk 330 are arranged, and a second member 312 that covers the front surface of the first member 311. The upper surface of the housing 310 is opened as a receiving port 313.

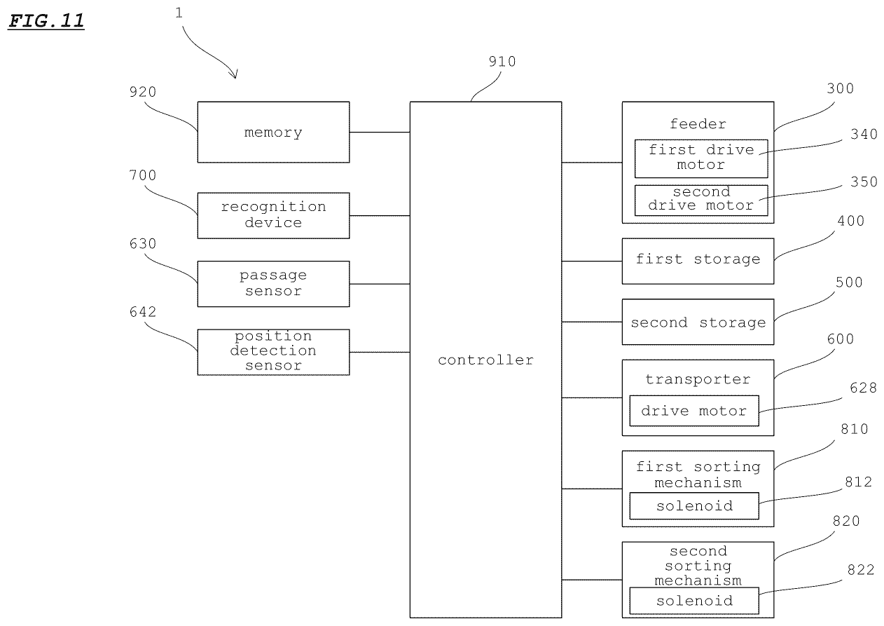

Within the housing 310, the rotating disk 320 and the delivery disk 330 are inclined at a predetermined angle with respect to the vertical direction. The rotating disk 320 has a number of hooks 321 formed protruding from the surface. The rotating disk 320 and the delivery disk 330 are rotated by the power of a first drive motor 340 (see FIG. 11) and a second drive motor 350, respectively.

When the rotating disk 320 rotates, coins within the housing 310, i.e., within the feeder 300, are hooked onto the hook 321 and transported to the outlet. The coin is delivered to the delivery disk 330 at the outlet section, and are sent out one by one to the transport path 611 of the transporter 600 by the rotation of the delivery disk 330.

The lower end of the return chute 603 of the transporter 600 is located directly above the receiving port 313 of the feeder 300. The return chute 603 extends obliquely upward, and its upper end is connected to the terminal end of the transport path 611 (second conveying surface 614) of the transporter 600. The return chute 603 is provided with guards 603a on both side edges.

The second storage 500 includes a housing 510, a shutter 520, and a drive motor 530. The bottom of the housing 510 is located directly above the receiving port 313 of the feeder 300, and extends obliquely upward from the bottom to the top so as to cover the upper part of the return chute 603. The housing 510 is provided with an inlet 511 at the top and an outlet 512 at the bottom. The shutter 520 has an arc shape and closes the outlet 512 of the housing 510. The drive motor 530 rotates the shutter 520. When the shutter 520 rotates open, the outlet 512 is exposed.

The second storage 500 is provided with a cover 540 that extends upward from the top of the housing 510 and covers the second conveying surface 614.

The inlet 511 of the second storage 500 is connected to an inlet portion of the return chute 603. The sorting member 821 of the second sorting mechanism 820 is disposed at the inlet 511 of the second storage 500. By the operation of a solenoid 822 (see FIG. 11), the distribution member 821 can be switched between a state in which the inlet 511 of the second storage 500 is closed and the inlet portion of the return chute 603 is opened (solid line in FIG. 4), and a state in which the inlet 511 of the second storage 500 is opened and the inlet portion of the return chute 603 is closed (dashed line in FIG. 4).

The transporter 600 includes a transport path member 610 and a transport mechanism 620. The transport path member 610 is formed of one or more members having a substantially plate shape. A transport path 611 is formed in the transport path member 610. The transport path 611 has a transport surface 612 on which coins are conveyed. The transport path member 610 is inclined with respect to the vertical direction, similar to the rotating disk 320 and the delivery disk 330 of the feeder 300. As a result, the transport path 611 and the transport surface 612 are also inclined with respect to the vertical direction.

The transport path 611, i.e., the transport surface 612, extends approximately horizontally from the feeder 300 in a rearward direction (first direction), then bends and extends diagonally upward, and then bends again and extends approximately horizontally in a forward direction (the opposite direction to the first direction) to reach the upper end position of the return chute 603. The transport surface 612 starts from the end on the feeder 300 side and ends at the upper end of the return chute 603. Although not shown in FIGS. 2 and 3, the upper portion of the transport path 611 is entirely covered by a plurality of transport path covers.

The transport mechanism 620 includes a first pulley 621, a second pulley 622, two third pulleys 623, a fourth pulley 624, and a transport belt 625.

The first pulley 621 is located near the feeder 300. The second pulley 622 is located above and in front of the first pulley 621. The two third pulleys 623 are located behind the first pulley 621 and the second pulley 622 and at the upper and lower corners of the transport path 611. The fourth pulley 624 is located between the first pulley 621 and the second pulley 622. The second pulley 622 and the third pulley 623 have the same diameter. The first pulley 621 has a larger diameter than the second pulley 622 and the third pulley 623, and the fourth pulley 624 has a smaller diameter than the second pulley 622 and the third pulley 623.

The transport belt 625 is an endless (circular) belt. The transport belt 625 is stretched around five pulleys 621 to 624, and is positioned above the transport surface 612 of the transport path 611 except for a portion between the first pulley 621 and the second pulley 622. The transport belt 625 is provided with a plurality of (for example, six) protrusions 627 at equal intervals, protruding from the belt body 626 toward the transport surface 612. Each protrusion 627 has a generally T-shape, with its lower surface adjacent to the transport surface 612. Each protrusion 627 contacts a coin on the transport surface 612.

The first pulley 621, the second pulley 622, the third pulley 623 and the fourth pulley 624 are toothed pulleys having a corrugated outer surface, and the transport belt 625 is a toothed belt having teeth on its inner and outer surfaces. These pulleys 621 to 624 may be pulleys that do not have corrugations, and the transport belt 625 may be a belt that does not have teeth. In FIGS. 3 and 5, only a part of the waveform of the transport belt 625 is shown.

A driving force is transmitted to the second pulley 622 from a drive motor 628 (see FIG. 11) included in the transport mechanism 620. As a result, the second pulley 622 rotates in a counterclockwise direction as viewed in FIG. 3, the transport belt 625 revolves in the same direction above the transport surface 612, and the multiple protrusions 627 move. The coins fed to the transport path 611 by the feeder 300 are pushed by the protrusions 627 and conveyed on the transport surface 612 toward the upper end side of the return chute 603. The direction from the feeder 300 side toward the upper end side of the return chute 603 is the direction in which the coins are transported by the transport belt 625.

The driving force of the drive motor 628 may be transmitted to the first pulley 621 or the third pulley 623 instead of the second pulley 622.

The protrusion 627 is a contact portion that comes into contact with the coin as the medium, and the transport belt 625 is a conveying member that pushes the medium by the contact portion and conveys it. The drive motor 628 is a drive source for driving the transport member.

In the transport path member 610, a sorting member 811 of a first sorting mechanism 810 is disposed at a position adjacent to and upstream of the second pulley 622 in the transport path 611. The sorting member 811 can be switched, by the operation of a solenoid 812 (see FIG. 11), between a state in which it guides coins to the storage chute 601, a state in which it guides coins to the dispensing chute 602, and a state in which it does not guide coins to either of storage chute 601 or dispensing chut 602.

The transport path member 610 has the recognition device 700 disposed at a position upstream and near a lower corner of the transport path 611. Further, the transport path member 610 has a plurality of (for example, four) passage sensors 630 disposed at predetermined positions of the transport path 611. The passage sensor 630 includes a pair of a light emitting element 631 and a light receiving element 632 arranged above the transport surface 612, and a reflecting prism 633 arranged on the rear side of the transport surface 612. An incident surface 633a and an exit surface 633b of the reflecting prism 633 are exposed from the transport surface 612. Light emitted from the light emitting element 631 enters the reflecting prism 633 from the incident surface 633a, exits from the exit surface 633b, and is received by the light receiving element 632. When a coin passes the position of the passage sensor 630, the light from the light emitting element 631 is blocked by the coin and does not reach the light receiving element 632. This allows the passing sensor 630 to detect the passage of the coin.

The transport surface 612 includes a first transport surface 613 and a second transport surface 614. The first transport surface 613 extends from the starting end of the transport path 611 to the position of the second pulley 622. A transport belt 625 exists above the first transport surface 613. Therefore, on the first transport surface 613, coins are transported by the transport belt 625.

The second transport surface 614 is located downstream of the first transport surface 613 in the transport direction of the transport belt 625. The second transport surface 614 extends from the first transport surface 613 in the forward direction, i.e., in the direction in which the medium travels at the end of the first transport surface 613 (the direction in which the protrusion 627 travels before it reaches the position of the second pulley 622 and changes direction of movement). The transport belt 625 is not present above the second transport surface 614, and coins that are separated from the protrusions 627 of the transport belt 625 are conveyed onto the second transport surface 614. The second transport surface 614 is disposed above the feeder 300 and guides coins returned to the feeder 300.

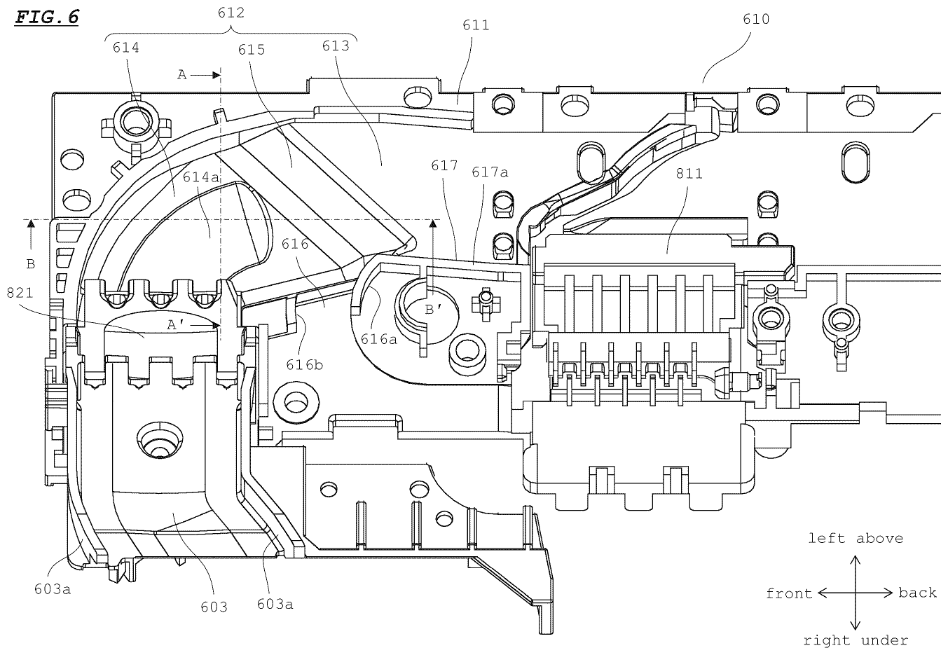

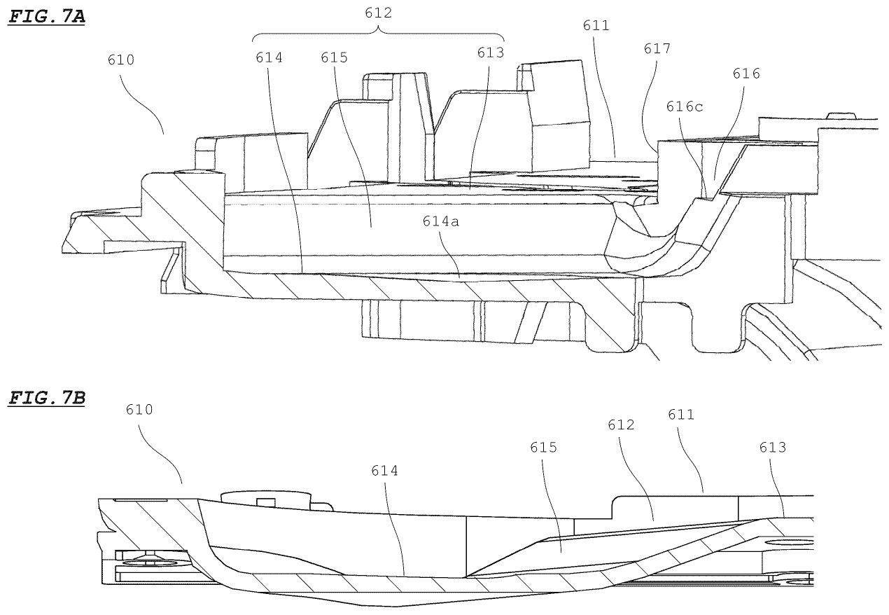

FIG. 6 illustrates the periphery of the second transport surface 614 of the transport path member 610. In particular, an inclined transport path member 610 as viewed from the horizontal direction. FIGS. 7A and 7B illustrate cross-sectional views of a main part of the transport path member 610 taken along the lines AA′ and BB′ in FIG. 6, respectively. In FIG. 6, in addition to the transport path member 610, the sorting member 811 of the first sorting mechanism 810, the sorting member 821 of the second sorting mechanism 820, and the return chute 603 are shown.

The transport surface 612 has a step 615 between a first transport surface 613 and a second transport surface 614, and the step 615 causes the second transport surface 614 to be recessed with respect to the first transport surface 613. The second transport surface 614 is recessed in a direction substantially perpendicular to the first transport surface 613 and on the side opposite to the side on which the transport belt 625 is provided.

The second transport surface 614 is inclined toward the lower right of the media processing device 1 and is connected to the upper end of the return chute 603. The second transport surface 614 has a non-flat region 614a that is not a flat surface. As shown in FIG. 7A, the non-flat region 614a is, for example, a bend surface having a substantially V-shape. The non-flat region 614a may be a curved surface. A part of the second transport surface 614 is a non-flat region 614a, and a flat surface exists around the non-flat region 614a. The second transport surface 614 may have a non-flat region 614a across it.

A gate 616 is provided on the transport path member 610 at the lower right side edge (one side edge) of the second transport surface 614 adjacent to the second transport surface 614. The gate 616 is formed between two ribs 616a, 616b extending in a lower right direction. The gate 616 is located on a lower side of the transport path member 610 than the second transport surface 614. The width of the gate 616 is greater than the lateral width of the protrusion 627 and smaller than the diameter of the smallest coin that the media processing device 1 is to process.

In the transport path member 610, a surface 616c on which the gate 616 is provided is substantially flush with the first transport surface 613. Therefore, the second transport surface 614 is recessed from the first transport surface 613 further than the surface 616c on which the gate 616 is provided.

The transport belt 625 is arranged to pass through the gate 616. The protrusion 627, which moves as the transport belt 625 rotates, moves downstream of the first transport surface 613, along the outer periphery of the second pulley 622, in a direction different from the direction (forward direction) in which the second transport surface 614 exists relative to the first transport surface 613 (to the lower right direction), and leaves the transport surface 612 from the lower right side edge (one side edge) of the transport surface 612 and passes through the gate 616.

The step 615 is provided at an angle to the width direction of the transport surface 612 so that the coin approaches the step 615 earlier the closer it is to the lower right side edge (the one side edge) of the transport surface 612 from which the protrusion 627 moves away. Furthermore, the step 615 is a slope that slopes downward from the first transport surface 613 towards the second transport surface 614. The gradient of the slope is, for example, 45 degrees or more.

The transport path member 610 is provided with a guide portion 617 on the lower right side edge side of the terminal end of the first transport surface 613 so as to be adjacent to the first transport surface 613. The guide portion 617 is constituted by a rib 617a extending along the side edge of the first transport surface 613 so as to move away from the gate 616 in the width direction of the first transport surface 613 as it approaches the second transport surface 614. In the width direction of the first transport surface 613, the gate 616 is farther from the first transport surface 613 than the guide portion 617 is.

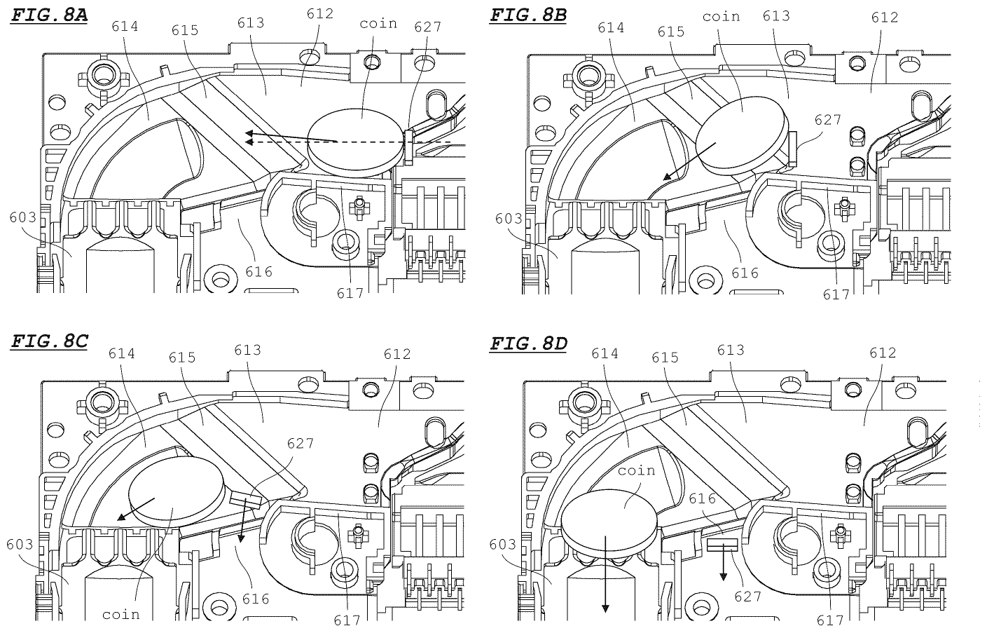

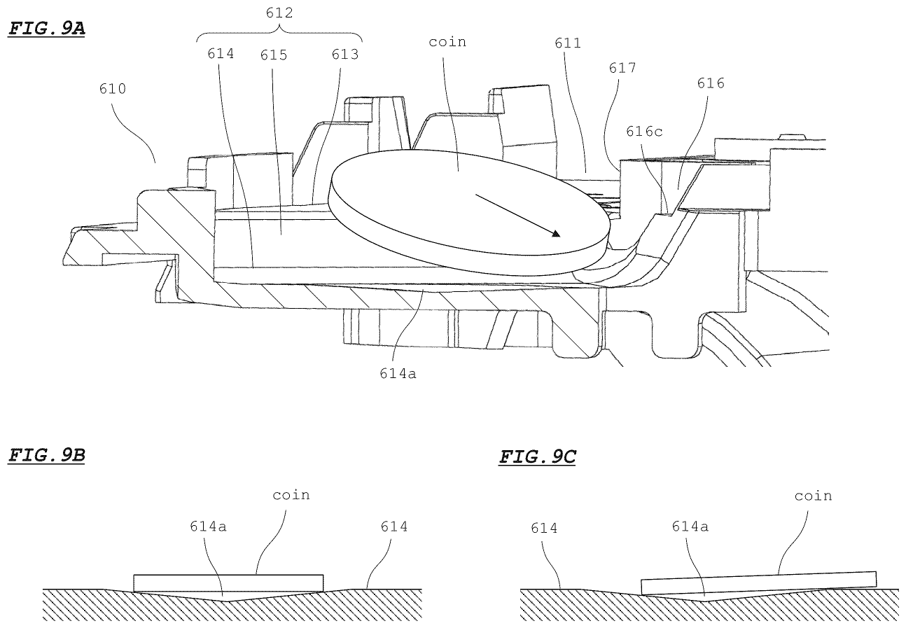

FIGS. 8A-8D and 9A-9C illustrate the movement of coins transported on the transport surface 612 from the end of the first transport surface 613 to the second transport surface 614.

As shown in FIG. 8A, a coin is pushed by the protrusion 627 and transported to the terminal end of the first transport surface 613, and comes into contact with the guide portion 617, and is guided by the guide portion 617 in the width direction of the first transport surface 613 so as to move away from the gate 616 as it approaches the second transport surface 614, as indicated by the solid arrow. In other words, the coin does not move in the direction indicated by the dashed arrow before reaching the terminal end of the first transport surface 613.

Next, as shown in FIG. 8B, when the coin reaches step 615, it tilts so that the leading side drops, and goes down the slope of step 615 toward second transport surface 614. Then, as shown in FIG. 8C, the coin reaches the second transport surface 614. The coin becomes lower than the lower surface of the protrusion 627 and moves away from the protrusion 627. The protrusion 627 from which the coin has been detached moves in a lower right direction relative to the first transport surface 613, which is different from the forward direction in which the second transport surface 614 exists.

Thereafter, as shown in FIG. 8D, the coin moves along the second transport surface 614 due to inertia and gravity and reaches the upper end of the return chute 603, and the protrusion 627 leaves the transport surface 612 from the lower right side edge in the width direction of the transport surface 612 and passes through the gate 616. When the entrance portion of the return chute 603 is opened by the sorting member 821, the coins slide down the return chute 603 and enter the feeder 300. On the other hand, when the inlet 511 of the second storage 500 is opened by the sorting member 821, the coins enter the second storage 500.

In the media processing device 1, a step 615 is provided that recesses the second transport surface 614 relative to the first transport surface 613. As a result, as the coin moves from the first transport surface 613 toward the recessed second transport surface 614, the coin easily detaches from the protrusion 627 smoothly on the way to the second transport surface 614. This makes it difficult for coins to be dragged along by the protrusion 627 moving in a direction different from the direction toward the second transport surface 614. Therefore, the coins can be smoothly moved from the first transport surface 613 to the second transport surface 614. In addition, it is possible to prevent the coin from being pulled by the projection 627 and caught in the gate 616, causing a jam.

In particular, the transport surface 612 is configured such that coins advance in a substantially horizontal direction toward the second transport surface 614 at the terminal end of the first transport surface 613. Therefore, at the terminal end of the first transport surface 613, gravity hardly acts on the coin in the direction in which the coin is transported, so it is unlikely that the coin will separate from the protrusion 627 due to the action of gravity. However, even if the effect of gravity cannot be expected, the provision of the step 615 makes it easier for the coin to be smoothly separated from the protrusion 627.

Furthermore, step 615 is formed diagonally with respect to the width direction of transport surface 612, and as shown by the arrow in FIG. 9A, the portion of the coin near the lower right side edge of transport surface 612, i.e., the side where protrusion 627 moves away from transport surface 612 and is near gate 616, moves down first and takes a lower position relative to protrusion 627. Therefore, when the protrusion 627 leaves the transport surface 612, it becomes easier for the protrusion 627 to separate from the coin, and the coin becomes easier to move to the second transport surface 614 more smoothly. Because the part of the coin closer to the gate 616 goes down first, the coin is more likely to be directed toward the upper end of the return chute 603, which is located lower than the second transport surface 614, as shown by the arrow in FIG. 8B, making it easier for the coin to head toward the upper end of the return chute 603.

Furthermore, since the second transport surface 614 is recessed from the first transport surface 613 by more than the surface 616c on which the gate 616 is provided, the coins reaching the second transport surface 614 are lower than the gate 616. This makes it more difficult for the coin to get caught in the gate 616. Furthermore, as shown in FIG. 9A, the portion of the coin closer to the gate 616 at the step 615 is tilted first and becomes lower than the surface 616c on which the gate 616 is provided. Therefore, the coin is less likely to get caught in the gate 616.

Furthermore, at the terminal end of the first transport surface 613, the coins are guided away from the gate 616 by the guide portion 617, so that the coins are less likely to be close to the gate 616 when they leave the first transport surface 613. This makes it even more difficult for coins to get caught in the gate 616. In the width direction of the first transport surface 613, the gate 616 is farther from the first transport surface 613 than the guide portion 617 is. Therefore, it is even less likely that the coins that have left the first transport surface 613 will come close to the gate 616.

Furthermore, as shown in FIGS. 9B and 9C, the coin moving on the second transport surface 614 passes through the non-flat area 614a, so that the contact area between the surface of the coin and the second transport surface 614 can be reduced. Therefore, even if the coin is wet or in a state in which the coefficient of friction is high, the frictional resistance generated between the surface of the coin and the second transport surface 614 is small, thereby preventing the coin from becoming difficult to slide on the second transport surface 614.

Furthermore, since the step 615 is inclined and the coins move down the slope, unlike when the step 615 is perpendicular to the first transport surface 613, the medium is less likely to float as it passes through the step 615 and fall onto the second transport surface 614, resulting in a floppy state. This allows the coins to move more smoothly onto the second transport surface 614.

Furthermore, since the transport belt 625 is not provided up to the second transport surface 614, the transport belt 625 can be made short.

The transporter 600 includes a position detection mechanism 640 for detecting the position of the protrusion 627 on the transport surface 612.

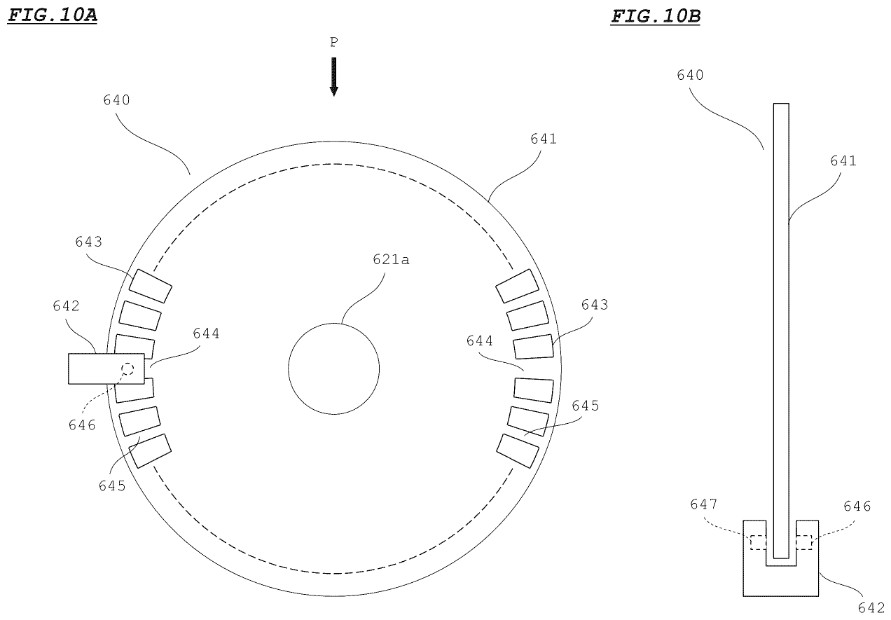

FIGS. 10A and 10B illustrate a configuration of the position detection mechanism 640. FIG. 10A is a diagram of the position detection mechanism 640 as viewed from the front of the detection disk 641, and FIG. 10B is a diagram of the position detection mechanism 640 as viewed from the P direction in FIG. 10A. In FIG. 10A, for the sake of convenience, the opening 643 is omitted in the dashed line portion.

The position detection mechanism 640 includes a detection disk 641 and a position detection sensor 642. The detection disk 641 is attached to a rotating shaft 621a of the first pulley 621 and rotates together with the first pulley 621. When the second pulley 622 rotates and the transport belt 625 rotates, the first pulley 621 rotates. When the transport belt 625 rotates by one pitch between the two protrusions 627, the first pulley 621 rotates half a turn and the detection disk 641 rotates half a turn.

A plurality of openings 643 are formed around the entire outer periphery of the detection disc 641. Of the multiple regions formed between two openings 643, two regions are wide regions 644 having a relatively wide width, and the remaining regions are narrow region 645 having a relatively narrow width. The distance between the two wide regions 644 is 180 degrees.

The position detection sensor 642 is disposed on the outer periphery of the detection disk 641. The position detection sensor 642 is a photosensor, and includes a light emitting element 646 and a light receiving element 647. When the wide region 644 and the narrow region 645 of the detection disk 641 pass the position of the position detection sensor 642, the light from the light emitting element 646 is blocked and does not reach the light receiving element 647. As a result, the position detection sensor 642 outputs a pulse signal having a width according to the light blocking time. That is, the position detection sensor 642 outputs a pulse signal with a relatively long width when the wide region 644 passes, and outputs a pulse signal with a relatively short width when the narrow region 645 passes.

When the position detection sensor 642 detects the passage of the wide area 644, the multiple protrusions 627 are present at a reference position on the transport surface 612. Each time the detection disk 641 rotates half a turn, each of the protrusions 627 moves by one pitch to a reference position, and the position detection sensor 642 detects the passage of the wide area 644. After the pulse signal corresponding to the wide region 644 is output from the position detection sensor 642, the number of pulse signals corresponding to the narrow region 645 output from the position detection sensor 642 can be counted to determine the position of the protrusion 627 from the reference position.

FIG. 11 illustrates a block diagram showing the main configuration of the media processing device 1.

In addition to the components described above, the media processing device 1 also includes a controller 910 and a memory 920.

The controller 910 includes an arithmetic circuit such as a CPU (Central Processing Unit). In an exemplary implementation, controller 910 is processing circuitry. The functionality of controller 910 disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The controller 910 controls the feeder 300, first storage 400, second storage 500, transporter 600, first sorting mechanism 810, second sorting mechanism 820, etc. in accordance with the operating program stored in the memory 920 based on each signal from the recognition device 700, the passage sensor 630, the position detection sensor 642, etc. This realizes the functions and operations of the media processing device 1. In particular, the processes described as being executed by the media processing device 1 are realized by the controller 910. The memory 920 includes storage media such as a ROM (Read Only Memory), a RAM (Random Access Memory) or a hard disk, stores the operating program for the controller 910, and is also used as a work area during control processing by the controller 910.

The media processing device 1 performs processes for depositing and dispensing coins.

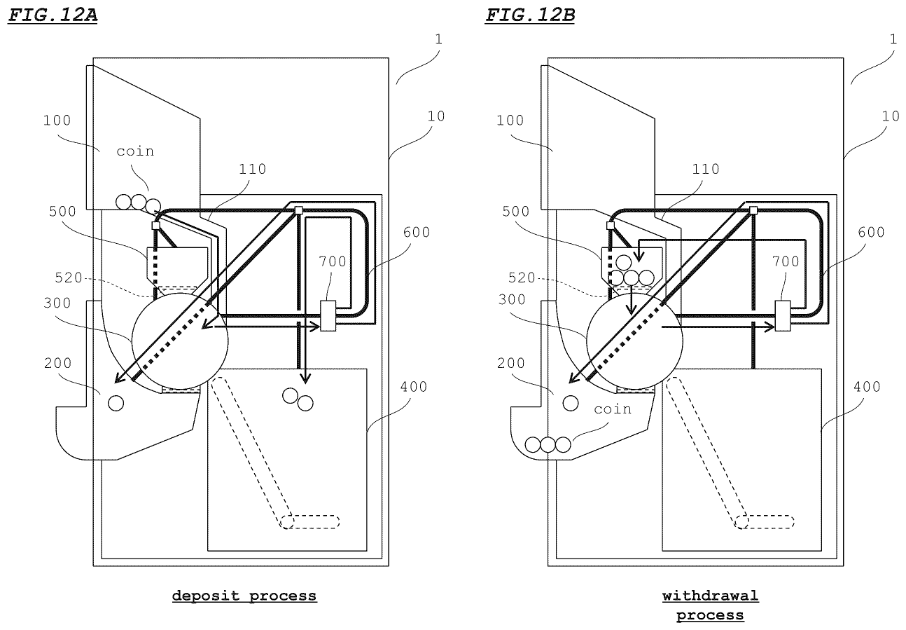

FIGS. 12A and 12B illustrate a deposit process and the withdrawal process, respectively, of the media processing device 1.

As shown in FIG. 12A, when a deposit process is started, coins inserted into the deposit port 100 are introduced into the feeder 300 through the deposit chute 110. The coins in the feeder 300 are dispensed to the transporter 600 (transport path 611). Coins flowing through the transporter 600 pass through the recognition device 700, where their attributes are recognized. As a result of the recognition by the recognition device 700, coins that are normal and whose denominations have been recognized are transported to the first storage 400 and stored therein. On the other hand, as a result of the recognition by the recognition device 700, abnormal coins or coins whose denominations could not be recognized are transported to the withdrawal port 200 and discharged therefrom. As the coins pass the recognition device 700, they are counted.

As shown in FIG. 12B, in the media processing device 1, coins to be dispensed are stored in a second storage 500 in advance in a mixed denomination state by a dispensing preparation process described below. When the dispensing process is started, the shutter 520 of the second storage 500 opens and the coins fall into the feeder 300. The coins in the feeder 300 are fed to the transporter 600 (transport path 611) and pass through the recognition device 700, where their denominations are recognized. Coins of the denomination to be dispensed are transported to the withdrawal port 200 and discharged from the withdrawal port 200. On the other hand, coins of denominations that are not eligible for withdrawal are returned to the second storage 500.

When a cash transaction is carried out and there are no coins in the second storage 500 or there are fewer coins than a specified reserve (appropriate amount), the media processing device 1 carries out a withdrawal preparation process.

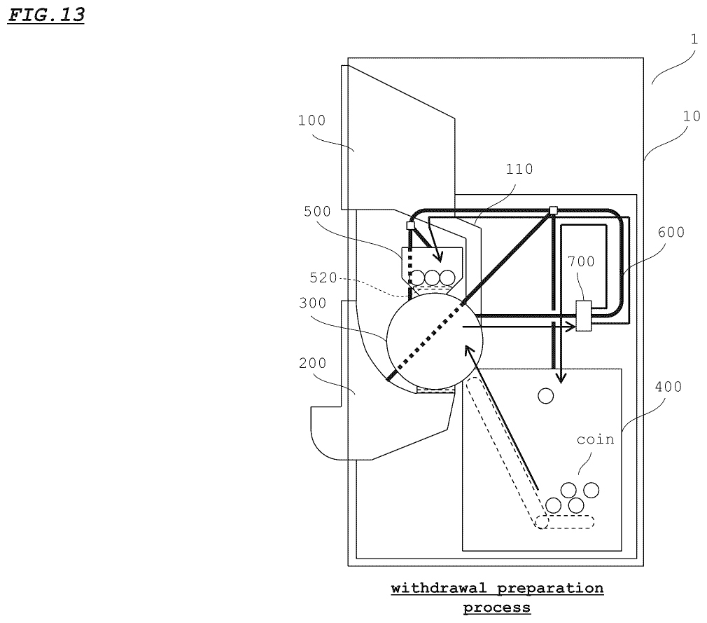

FIG. 13 illustrates the withdrawal preparation process of the media processing device 1.

When the dispensing preparation process is started, coins are transported from the first storage 400 to the feeder 300, and then the coins are dispensed from the feeder 300 to the transporter 600 (transport path 611). The denominations of the coins are identified by the recognition device 700, and coins of a denomination that requires replenishment are transported to the second storage 500, while coins of a denomination that does not require replenishment are returned to the first storage 400. When the appropriate amount of coins is stored in the second storage 500, the withdrawal preparation process is completed.

In addition, if the media processing device 1 is forcibly stopped due to a power outage or the like during a deposit or withdrawal process and then returns to operation, the coins remaining in the transporter 600 are returned to the feeder 300 via the return chute 603.

In the media processing device 1, during deposit processing, withdrawal processing, and withdrawal preparation processing, coin jams may occur during coin transport by the transporter 600. As described above, a configuration is adopted in which coins moving from the first transport surface 613 to the second transport surface 614 are less likely to get caught in the gate 616. However, it is possible that a coin may get caught in the gate 616, causing a jam around the step 615.

Therefore, the media processing device 1 monitors for the occurrence of a jam, and if a jam occurs, the appropriate process is carried out. The jam handling process will now be described.

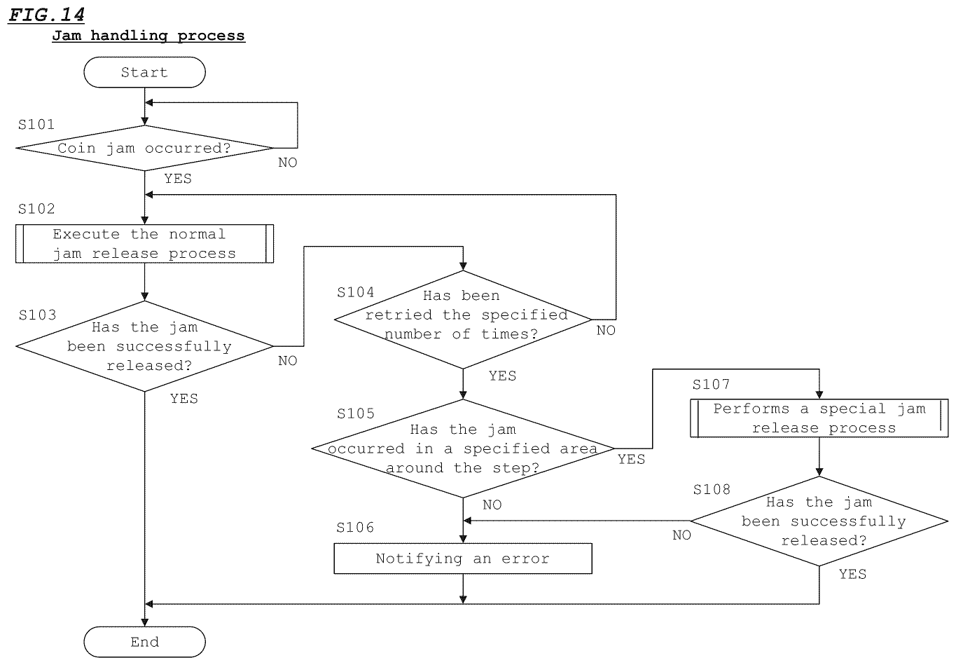

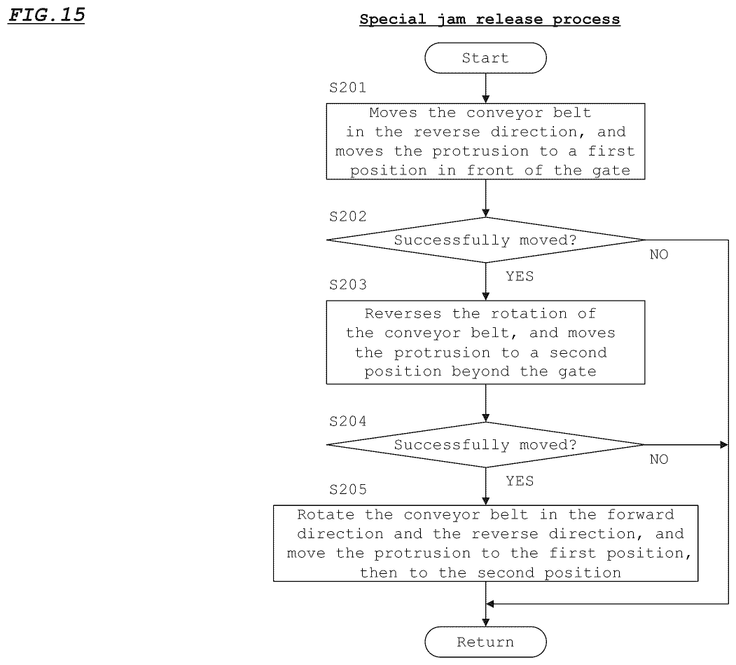

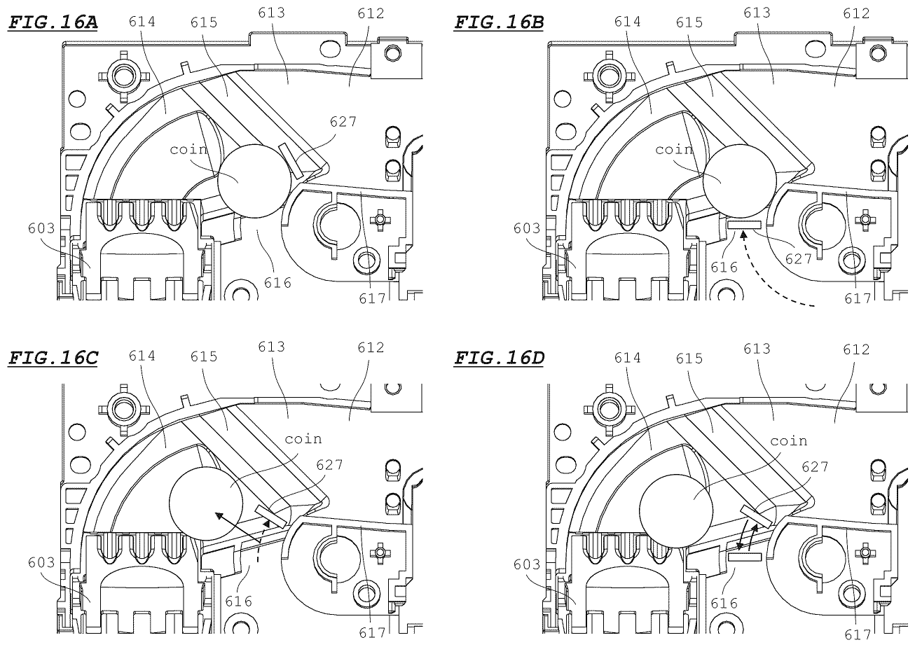

FIG. 14 illustrates a jam handling process of the media processing device 1. FIG. 15 illustrates a special jam release process included in the jam handling process. FIGS. 16A-16D illustrate the jam handling process.

For example, when a coin transport process, such as the deposit process, the withdrawal process, or the withdrawal preparation process, is started, the jam handling process is started.

Referring to FIG. 14, the controller 910 monitors whether or not a coin jam has occurred (S101). When a jam occurs, the coin stops moving, so the protrusion 627 also stops moving, and the transport belt 625 stops. When this occurs, the first pulley 621 stops, so that the position detection sensor 642 stops outputting a pulse signal or continues to output a pulse signal. That is, the pulse signal is not output normally. If the pulse signal is no longer being output normally even though the drive motor 628 that drives the transport belt 625 is operating, the controller 910 determines that a coin jam has occurred.

When the controller 910 determines that a jam has occurred (S101: YES), the control unit 910 executes a normal jam release process corresponding to the jam that has occurred on the first transport surface 613 (S102). In the normal jam release process, the controller 910 rotates the drive motor 628 in the reverse direction to rotate the transport belt 625 in the reverse direction, and moves the protrusion 627 a predetermined amount in the direction opposite to the conveying direction. Thereafter, the controller 910 rotates the drive motor 628 in the forward direction to rotate the transport belt 625 in the forward direction, and moves the protrusions 627 in the conveying direction. That is, the protrusion 627 is once retracted away from the coin, and then moved forward, thereby release the jam.

Next, the controller 910 determines whether or not the jam has been successfully released (S103). When the jam is released, the pulse signal returns to a normal output state.

When the controller 910 determines that the jam has been successfully released (S103: YES), the controller 910 ends the jam handling process. When the jam is released, the transporter 600 resumes conveying coins. Once the jam handling process is completed, it is immediately restarted.

On the other hand, if the controller 910 determines that the jam has not been released (S103: NO), and the normal jam release process has not been retried the specified number of times (S104: NO), the controller 910 performs the normal jam release process again (S102).

If the normal jam release process is retried a specified number of times without the jam being released (S104: YES), the controller 910 determines whether a jam has occurred in a specified area around the step 615 due to the coin getting caught in the gate 616 (S105). At this time, the controller 910 detects the position of the protrusion 627 by the position detection mechanism 640, and determines whether or not a jam has occurred within a specified area around the step 615 based on the position of the protrusion 627 when the jam occurred.

As shown in FIG. 16A, when a coin gets caught in gate 616 and jams within a specified area around the step 615, protrusion 627 pushing the coin is present within a range that corresponds to the specified area. Also, immediately before the jam occurs, the coin passes through the passage sensor 630 that is closest to the step 615.

The range of the number of times the position detection sensor 642 generates a pulse signal from the reference position when the protrusion 627 is in the corresponding range is stored in the memory 920 as a specified number range. While the transporter 600 is conveying coins, the controller 910 constantly counts the number of times that a pulse signal is generated by the position detection sensor 642 from the reference position, and if the number of occurrences when a jam occurs is within a specified area, it determines that the protrusion 627 is present within the corresponding range. Then, the controller 910 determines that a jam has occurred in a specified area around the step 615 if the protrusion 627 is present in the corresponding range and the passing sensor 630 closest to the step 615 detects the passage of a coin just before a jam occurs.

In addition, the controller 910 may determine whether or not a jam has occurred within a specified area around the step 615 based only on the position of the protrusion 627 when the jam occurs, without considering the passage of the coin by the passing sensor 630.

Furthermore, the range of time required to reach the corresponding range from the reference position may be stored in the memory 920 as the specified time range. In this case, the controller 910 constantly counts the elapsed time from the reference position while the transporter 600 is transporting the coin, and if the elapsed time when the jam occurred is within a specified time range, it determines that the protrusion 627 is present within the corresponding range.

When the controller 910 determines that no jam has occurred within a predetermined area around the step 615 (S105: NO), it performs a process for notifying an error (S106). For example, if the media processing device 1 is equipped with a display and sound output device (speaker), the controller 910 will notify the user of the error by displaying an image on the display unit or by producing a voice or alert sound from the sound output unit. Furthermore, if the media processing device 1 is communicatively connected to an information terminal device, the controller 910 sends a notification command to the information terminal device to cause the information terminal device to notify the user of an error.

Thus, the jam handling process is completed. Based on the error notification, an attendant removes the jammed coin and releases the jam. When the transport of coins by the transporter 600 is resumed, the jam handling process is restarted.

On the other hand, when the controller 910 determines that a jam has occurred in a predetermined area around the step 615 (S105: YES), the controller 910 performs a special jam release process corresponding to the jam (S107).

Referring to FIG. 15, the controller 910 rotates the drive motor 628 in the reverse direction to rotate the transport belt 625 in the reverse direction, and moves the protrusion 627, which is one pitch ahead of the protrusion 627 around the step 615 in the conveying direction and is positioned in a direction away from the transport surface 612 than the gate 616, in the opposite direction to the conveying direction to a predetermined first position in front of the gate 616 (S201).

The memory 920 stores the number of times that the position detection sensor 642 generates a pulse signal when the protrusion 627 is moved in the reverse direction from the reference position to the first position. The controller 910 moves the leading protrusion 627 in the reverse direction to return it to the reference position, and then further moves the protrusion 627 in the reverse direction by the number of times the pulse signal has been generated up to the first position. As a result, the protrusion 627 reaches the first position as shown in FIG. 16B.

When the controller 910 has successfully moved the protrusion 627 to the first position (S202: YES), it reverses the rotation of the transport belt 625 again to move the protrusion 627 to a predetermined second position beyond the gate 616 (S203). The memory 920 stores the number of times that the position detection sensor 642 generates a pulse signal required for movement from the first position to the second position, and the controller 910 moves the protrusion 627 the number of times that the pulse signal is generated. As shown in FIG. 16C, when the protrusion 627 moves to the second position, the coin caught in the gate 616 is pushed toward the second transport surface 614 by the protrusion 627, and moves away from the gate 616 to the second transport surface 614.

When the controller 910 has successfully moved the protrusion 627 to the second position (S204: YES), it rotates the transport belt 625 in the forward direction, moves the protrusion 627 to the first position, and then rotates the transport belt 625 in the reverse direction, and moves the protrusion 627 again to the second position. (S205). As shown in FIG. 16D, the protrusion 627 reciprocates between the second position and the first position. As a result, even if the coin does not move sufficiently away from the gate 616 when it is first pushed by the protrusion 627 and returns to the gate 616 side due to its own weight or the like, the coin can be pushed away from the gate 616 by the protrusion 627.

In this manner, the controller 910 ends the special jam release process. At this time, the controller 910 determines that the coin jam around the step 615 has been released.

When the protrusion 627 is being moved to the first position in S201, it is possible that a new jam occurs on the first transport surface 613, causing the protrusion 627 to stop before reaching the second position. In this case, the controller 910 determines that the movement of the protrusion 627 to the first position has failed (S202: NO), and ends the special jam release process. Furthermore, when the protrusion 627 is moved to the second position, the coin may not be released from the gate 616 and the protrusion 627 may be stopped by the coin. In this case, the controller 910 determines that the movement of the protrusion 627 to the second position has failed (S204: NO), and ends the special jam release process. In this way, if the special jam release process ends midway, the controller 910 determines that the coin jam around the step 615 has not been released.

Returning to FIG. 14, the controller 910 determines whether or not the jam has been successfully released by the special jam release process (S108). If the controller 910 has succeeded in releasing the jam (S108: YES), the controller 910 immediately ends the jam handling process. On the other hand, if the controller 910 has failed to release the jam (S108: NO), the controller 910 performs a process for notifying an error in S106, and then ends the jam handling process.

In this way, by executing the jam handling process, it is possible to release not only coin jams that occur on the first transport surface 613, but also jams that occur around the gate 616, i.e., the step 615.

The media processing device (coin processing device) 1 can be combined, for example, with an information terminal device for performing payment operations for transaction objects such as goods, and a banknote processing device for processing such as depositing and withdrawing banknotes, to form an automated transaction device (kiosk) installed in restaurants, etc., or a self-checkout device or semi-self-checkout device installed in retail stores such as supermarkets. In this case, the media processing device 1 functions as a coin change machine, accepting coins as payment for merchandise and other transaction items, and dispensing coins as change.

The media processing device (coin processing device) 1 can be combined with an information terminal device and a banknote processing device to form an automated teller machine (ATM) installed in financial institutions, convenience stores, etc., and a currency deposit and withdrawal machine or teller system installed in financial institutions.

In an automated transaction device, an automated teller machine, or the like, the media processing device 1 may have a housing 10 separate from the banknote processing device, or may have a housing 10 shared with the banknote processing device.

### Example of Variations

Although embodiments of the present disclosure have been described above, the present disclosure is not limited to the above embodiments, and various modifications of the embodiments are possible.

For example, the step 615 may be parallel to the width direction of the transport surface 612 instead of being oblique to the width direction of the transport surface 612. The step 615 does not have to be an inclined surface.

The gate 616 does not have to be farther from the first transport surface 613 than the guide portion 617 is from the first transport surface 613 in the width direction of the first transport surface 613, and may be located at the same position as the guide portion 617.

The guide portion 617 may not be provided, and the coins may move at the terminal end of the first transport surface 613 in the same traveling direction as they were before reaching the terminal end.

The second transport surface 614 does not necessarily have to have the non-flat region 614a.

A coin detector for detecting coins, such as a photosensor, may be located near the entrance of gate 616, and in S105 of the jam handling process in FIG. 14, the controller 910 may be configured to determine that a jam has occurred in a specified area around step 615 when the coin detector detects a coin.

In the special jam release process of FIG. 15, the controller 910 may perform a process of moving the protrusion 627, which has been moved in the direction opposite to the conveying direction, to the second position in one go without stopping it at the first position, instead of the processes of S201 to S203. The process of S205 in which the protrusion 627 is reciprocated between the second position and the first position does not need to be performed.

The second storage 500 does not necessarily have to be provided above the feeder 300.

The media processing device 1 may be provided with a transport member having a contact portion other than the transport belt 625.

The present disclosure can also be applied to media processing devices other than the media processing device 1 (coin processing device) shown in the above embodiments, which performs processes such as depositing and withdrawing coins, as long as the media is transported by a transport member, such as a medal lending device that performs a medal lending process for use in gaming machines, etc.

1. A media processing device, comprising:
a transport surface along which a medium is transported; and
a transporter having a contact portion with which the medium comes into contact, the contact portion pushing and transporting the medium, wherein
the transport surface includes:
a first transport surface along which the medium is transported by the transporter; and
a second transport surface that is located downstream of the first transport surface in a transport direction of the transporter, the second transport surface along which the medium separated from the contact portion is transported,
the contact portion moves in a different direction which is different from the transport direction relative to the first transport surface on a downstream side of the first transport surface, and
a step is between the first transport surface and the second transport surface such that the second transport surface is recessed with respect to the first transport surface.

2. The media processing device according to claim 1, wherein the second transport surface extends from the first transport surface in a medium traveling direction at an end of the first transport surface.

3. The media processing device according to claim 1, wherein
the transporter includes an endless transport belt,
the contact portion includes a protrusion protruding from the transport belt toward the transport surface, and
the protrusion moves in the different direction along an outer periphery of a pulley around which the transport belt is wound, on the downstream side of the first transport surface.

4. The media processing device according to claim 1, further comprising a feeder that feeds the medium onto the first transport surface, wherein
the second transport surface is disposed above the feeder and guides the medium to be returned to the feeder, and
the contact portion moves in the different direction above the feeder and separates from the transport surface.

5. The media processing device according to claim 4, further comprising a storage disposed above the feeder and in which the medium is stored.

6. The media processing device according to claim 5, further comprising a sorting mechanism for sorting the medium guided by the second transport surface to the feeder or the storage.

7. The media processing device according to claim 1, wherein
the contact portion moves in the different direction and leaves the transport surface from one side edge of the transport surface, and
the step is provided obliquely with respect to a width direction of the transport surface such that the medium approaches the step earlier the closer it is to one side edge of the transport surface.

8. The media processing device according to claim 1, wherein the step is a slope.

9. The media processing device according to claim 1, further comprising:
a gate adjacent to the transport surface through which the contact portion moves in the different direction; and
a guide portion that guides the medium transported on the first transport surface so as to move away from the gate in a width direction of the first transport surface as the medium approaches the second transport surface.

10. The media processing device according to claim 9, wherein in the width direction of the first transport surface, the gate is farther from the first transport surface than the guide portion.

11. The media processing device according to claim 1, further comprising a gate adjacent to the transport surface through which the contact portion moves in the different direction, wherein
the second transport surface is recessed with respect to the first transport surface below a surface on which the gate is provided.

12. The media processing device according to claim 1, wherein the second transport surface has a non-flat region that is not a flat surface.

13. The media processing device according to claim 1, further comprising:
a drive source for driving the transporter; and
a control circuit that controls the driving source, wherein
when the control circuit determines that a medium jam has occurred in a predetermined area around the step, the control circuit executes a jam release process to operate the drive source so that the control circuit performs a movement to release the jam.

14. The media processing device according to claim 13, further comprising a gate adjacent to the transport surface through which the contact portion moves in the different direction, wherein
the transporter is provided with a plurality of the contact portions, and
the control circuit, as the jam release process, operates the drive source so that the contact portion, which is located in a direction away from the gate on the transport surface, moves toward the gate and passes the position of the gate.

15. The media processing device according to claim 13, wherein the control circuit detects a position of the contact portion, and determines whether or not the jam has occurred within the predetermined area based on the position of the contact portion when a medium jam has occurred.

16. A coin processing device, comprising:
a first transport surface;
a second transport surface;
a transporter having a contact portion with which a coin comes into contact, the contact portion pushing and transporting the coin along the first transport surface, wherein
the second transport surface is located downstream of the first transport surface in a transport direction of the transporter,
the coin is separated from the contact portion at the second transport surface and transported along the second transport surface,
the contact portion moves in a different direction which is different from the transport direction relative to the first transport surface on a downstream side of the first transport surface, and
the second transport surface is recessed with respect to the first transport surface.

17. The coin processing device according to claim 16, wherein the second transport surface extends from the first transport surface in a coin traveling direction at an end of the first transport surface.

18. The coin processing device according to claim 16, wherein
the transporter includes an endless transport belt,
the contact portion includes a protrusion protruding from the transport belt, and
the protrusion moves in the different direction along an outer periphery of a pulley around which the transport belt is wound, on the downstream side of the first transport surface.

19. The coin processing device according to claim 16, further comprising a feeder that feeds the coin onto the first transport surface, wherein
the second transport surface is disposed above the feeder and guides the coin to be returned to the feeder, and
the contact portion moves in the different direction above the feeder.

20. The coin processing device according to claim 19, further comprising a storage disposed above the feeder and in which the coin is stored.
